(19) United States
(12) Patent Application Publication
(10) Pub. No.: US 2026/0323215 A1
(43) Pub. Date: Oct. 15, 2026

(54) SOUND PRODUCING UNIT AND ELECTRONIC DEVICE

(71) Applicant: Goertek Inc., Shandong (CN)

(72) Inventors: JIE LI, Shandong (CN); Ting Zhu, Shandong (CN); Guodong Zhao, Shandong (CN); Huawei Liu, Shandong (CN)

(73) Assignee: Goertek Inc., Shandong (CN)

(21) Appl. No.: 18/880,704

(22) PCT Filed: Nov. 16, 2023
(86) PCT No.: PCT/CN2023/132004

§ 371 Date: Jan. 2, 2025

(30) Foreign Application Priority Data
Nov. 10, 2023 (CN) 202323031771.0

(51) Int. Cl. H04R 9/02; H04R 1/02; H04R 7/04; H04R 7/18; H04R 9/04; H04R 9/06

(52) U.S. Cl. CPC H04R 9/025; H04R 1/023; H04R 1/025; H04R 7/04; H04R 7/18; H04R 9/043; H04R 9/045; H04R 9/06

(57) ABSTRACT

Disclosed include a sound producing unit and an electronic device. The sound producing unit includes a housing and a magnetic circuit system. The housing is at least in part composed of a cobalt alloy material. The magnetic circuit system is provided on the housing, and includes a magnetic conducting yoke, a central magnetic part, and an edge magnetic part, the central magnetic part and the edge magnetic part being respectively provided on the magnetic conducting yoke, the edge magnetic part being provided on an outer side of the central magnetic part and connected to the housing.

### CROSS-REFERENCE TO RELATED APPLICATIONS

This application is a National Stage of International Application No. PCT/CN2023/132004, filed on Nov. 16, 2023, which claims priority to Chinese Patent Application No. 202323031771.0, filed on Nov. 10, 2023, both of which are hereby incorporated by reference in their entireties.

### TECHNICAL FIELD

The present disclosure relates to the technical field of electroacoustic transducing, and in particular to a sound producing unit and an electronic device using the same.

### BACKGROUND

With rapid development of science and technology, electronic devices such as mobile phones are being used more and more, and performance demands on speakers therein are becoming higher and higher, not only for video and audio playback, but also for sound quality and reliability of playback. In this connection, as users' demand on lightweight design of electronic devices becomes higher and higher, sound producing devices (such as speakers) in electronic devices are becoming smaller and smaller under influences of appearance and structure of electronic devices. A sound producing device, as an important and indispensable functional component of an electronic device, is an important part in the lightweight design of an electronic device. Therefore, lightweight design of a sound producing device is of extreme importance.

In the related art, miniaturization and thin design of electronic devices is mainly focused on thin design of magnetic circuit system of a sound producing device. However, a thinned magnetic circuit system of the sound producing device cannot meet the demands on magnetic field strength and results in a decrease in BL value, which influences acoustic performance and sound producing effect. As such, there is a dilemma that the thin design and sound producing performance cannot be balanced.

### SUMMARY

The present disclosure mainly aims at providing a sound producing unit and an electronic device, and intends to provide a sound producing unit that meets demands on both thin design and acoustic performance.

In order to achieve the above purpose, the present disclosure proposes a sound producing unit, which comprises:
a housing, which is at least in part composed of a cobalt alloy material; and
a magnetic circuit system provided on the housing, the magnetic circuit system comprising a magnetic conducting yoke, a central magnetic part, and an edge magnetic part, the central magnetic part and the edge magnetic part being respectively provided on the magnetic conducting yoke, the edge magnetic part being provided on an outer side of the central magnetic part and connected to the housing.

In one embodiment, a cobalt alloy material of the housing is of a material grade of Co50 or Co27.

In one embodiment, the central magnetic part comprises a central magnetic steel and a central magnetic conducting plate, the central magnetic steel having two opposite sides respectively connected to the central magnetic conducting plate and the magnetic conducting yoke; the edge magnetic part comprises an edge magnetic steel and an edge magnetic conducting plate, the edge magnetic steel having two opposite sides respectively connected to the edge magnetic conducting plate and the magnetic conducting yoke; the central magnetic conducting plate and/or the edge magnetic conducting plate being composed of a cobalt alloy material.

In one embodiment, a cobalt alloy material of the central magnetic conducting plate is of a material grade of Co50 or Co27; and/or,

a cobalt alloy material of the edge magnetic conducting plate is of a material grade of Co50 or Co27; and/or, a cobalt alloy material in any one of the housing, the central magnetic conducting plate, and the edge magnetic conducting plate is of a magnetic conductivity of no less than 5200 Gs/Oe; and/or,

a cobalt alloy material in any one of the housing, the central magnetic conducting plate, and the edge magnetic conducting plate is of a saturation magnetic induction intensity B of no less than 2.25 T.

In one embodiment, the edge magnetic conducting plate is of a thickness of no greater than 0.23 mm; and/or,
the central magnetic conducting plate is of a thickness of no greater than 0.23 mm; and/or,
the magnetic conduction yoke is of a thickness of no greater than 0.23 mm.

In an embodiment, the sound producing unit further comprises a vibration system which comprises a diaphragm, the diaphragm comprising: a corrugated rim, an inner fixing part provided on an inner side of the corrugated rim, and an outer fixing part provided on an outer side of the corrugated rim, the outer fixing part being connected to the housing, the corrugated rim being provided to be recessed towards the edge magnetic conducting plate, the edge magnetic conducting plate being provided with a first avoidance slot which is opposite to the corrugated rim and extends away from the diaphragm, the first avoidance slot being of a depth of no greater than 0.1 mm.

In an embodiment, the magnetic conducting yoke is composed of a cobalt alloy material which is of a material grade of Co50 or Co27.

In one embodiment, a cobalt alloy material of the magnetic conducting yoke is of a magnetic conductivity of no less than 5200 Gs/Oe; and/or,
a cobalt alloy material of the magnetic conducting yoke is of a saturation magnetic induction intensity B of no less than 2.25 T.

In an embodiment, the edge magnetic part and the central magnetic part are provided spaced apart to form a magnetic gap; the sound producing unit further comprises a vibration system which comprises a diaphragm assembly, a voice coil and a damper assembly; an outer circumference of the diaphragm assembly being fixed to the housing, a first end of the voice coil being connected to the diaphragm assembly, a second end of the voice coil being inserted into the magnetic gap, two ends of the damper assembly are respectively connected to the second end of the voice coil and to the housing, the magnetic conducting yoke is provided with a second avoidance slot opposite to the damper assembly which extends away from the damper assembly, with a depth of the second avoidance slot being between 0.05 mm and 0.15 mm.

In an embodiment, the diaphragm assembly comprises a diaphragm and a vibrating plate, an outer circumference of the diaphragm being connected to the housing, the vibrating plate being connected to the diaphragm and to the first end of the voice coil, the vibrating plate comprises a main body part and a beading part provided on an outer circumference of the main body part, the beading part being bent towards the magnetic system relative to the main body part, the diaphragm being provided on an inner side thereof an inner fixing part connected to the beading part, a top surface of the inner fixing part and a top surface of the main body part being located in the same plane.

In an embodiment, the housing comprises a first edge part and a second edge part in head-to-tail connection to each other, the first edge part being formed as a cobalt alloy material piece, the second edge part being formed as a plastic material piece, the second edge part being provided with a sound hole in communication with an acoustic cavity inside the housing; the housing further comprising a mesh assembly that covers the sound hole, the mesh assembly being adhesively connected to the second edge part or integrally molded with the second edge part.

In an embodiment, the edge magnetic part comprises an edge magnetic steel and an edge magnetic conducting plate, the edge magnetic steel having two opposite sides respectively connected to the edge magnetic conducting plate and the magnetic conducting yoke; the edge magnetic conducting plate comprising a first edge magnetic conducting plate located on the first edge part and a second edge magnetic conducting plate located on the second edge part, the first edge magnetic conducting plate and the first edge part being formed as an integral molding piece.

In an embodiment, the housing comprises a first edge part, a second edge part, and a connecting part, the first edge part and the second edge part intersecting at a position which forms a corner, the connecting part being located at the corner and is connected respectively to the first edge part and the second edge part, the connecting part being formed as a plastic material piece, and the first edge part and the second edge part being formed as cobalt alloy material pieces.

In an embodiment, the edge magnetic part comprises an edge magnetic steel and an edge magnetic conducting plate, the edge magnetic steel having two opposite sides respectively connected to the edge magnetic conducting plate and the magnetic conducting yoke; the edge magnetic conducting plate comprising a first edge magnetic conducting plate located on the first edge part and a second edge magnetic conducting plate located on the second edge part, the first edge magnetic conducting plate and the first edge part being formed as an integral molding piece, and the second edge magnetic conducting plate and the second edge part being formed as an integral molding piece.

In an embodiment, the sound producing unit is of a height no greater than 1.8 mm.

The present disclosure also proposes an electronic device comprising the sound producing unit described above.

The sound producing unit of the technical solution of the present disclosure provides a housing which is at least in part composed of a cobalt alloy material, so that the magnetic circuit system is provided on the housing. A central magnetic part and an edge magnetic part of the magnetic circuit system are respectively provided on the magnetic conducting yoke, the edge magnetic part being provided on an outer side of the central magnetic part. By connecting the edge magnetic part to the housing, the housing made of a cobalt alloy material is connected to the edge magnetic part, therefore, high saturation magnetic induction intensity of the housing is used to cooperate with the magnetic circuit system in the sound producing unit, so as to effectively meet the magnetic field intensity demands of the magnetic circuit system. This allows the sound producing unit to effectively improve the saturation magnetic induction intensity of a magnetic conducting material under a given constant size, thereby enhancing the BL value, improving acoustic performance and sound producing effect.

### BRIEF DESCRIPTION OF THE DRAWINGS

In order to clearly illustrate technical solutions in the embodiments of the present disclosure or the prior art, the drawings required for describing the embodiments or the prior art will be briefly introduced below. It is obvious that the drawings described below are only some of the embodiments of the present disclosure. For those skilled in the art, other drawings can be obtained based on the structures shown in these drawings without creative efforts.

FIG. 1 is a schematic explosive illustration of a sound producing unit in an embodiment of the present disclosure;

FIG. 2 is a partial cross-sectional schematic illustration of a sound producing unit in an embodiment of the present disclosure;

FIG. 3 is a schematic structural illustration of a housing according to an embodiment of the present disclosure;

FIG. 4 is a schematic structural illustration of the housing in another embodiment of the present disclosure;

FIG. 5 is a top view of the schematic structural illustration of the housing according to an embodiment of the present disclosure;

FIG. 6 is a schematic structural illustration of a magnetic conducting yoke in an embodiment of the present disclosure.

### REFERENCE SIGNS

| Reference | | Reference | |
|---|---|---|---|
| Sign | Name | Sign | Name |
| 100 | Sound Producing Unit | 2322 | Second Edge Magnetic |
| | | | Conducting Plate |
| 1 | Housing | 233 | First Avoidance Slot |
| 11 | First Edge Part | 24 | Magnetic Gap |
| 12 | Second Edge Part | 3 | Vibration System |
| 13 | Connecting Part | 31 | Diaphragm Assembly |
| 14 | Sound Hole | 311 | Diaphragm |
| 2 | Magnetic Circuit System | 3111 | Corrugated Rim |
| 21 | Magnetic Conducting | 3112 | Inner Fixing Part |
| | Yoke | | |
| 211 | Second Avoidance Slot | 3113 | Outer Fixing Part |
| 22 | Central Magnetic Part | 312 | Vibrating Plate |
| 221 | Central Magnetic Steel | 3121 | Main Body Part |
| 222 | Central Magnetic | 3122 | Beading Part |
| | Conducting Plate | | |
| 23 | Edge Magnetic Part | 32 | Sound Coil |
| 231 | Edge Magnetic Steel | 321 | First End |
| 232 | Edge Magnetic | 322 | Second End |
| | Conducting Plate | | |
| 2321 | First Edge Magnetic | 33 | Damper Assembly |
| | Conducting Plate | | |

Realization of the purpose of the present disclosure, as well as functional characteristics and advantages thereof will be further explained with reference to the accompanying drawings in conjunction with the embodiments.

### DETAILED DESCRIPTION

The technical solutions in the embodiments of the present disclosure will be clearly and thoroughly described below in conjunction with the accompanying drawings. It is apparent that the described embodiments are only a part of the embodiments of the present disclosure, rather than all of them. Based on the embodiments of the present disclosure, all other embodiments obtained by those skilled in the art without creative work shall fall within the scope of protection of the present disclosure.

It should be noted that all directional indications (such as up, down, left, right, front, back, etc.) in the embodiments of the present disclosure are only used to explain the relative positional relationships and motion situations between various components in a specific posture (as shown in the figures). If the specific posture changes, the directional indications will also change accordingly.

Meanwhile, the meaning of “and/or” or “or/and” in the whole text is that it includes three options, taking “A and/or B” as an example, including an option A, an option B, or an option of both A and B.

In addition, in the present disclosure, descriptions involving “first”, “second”, etc. are only for descriptive purposes and cannot be understood as indicating or implying their relative importance or implicitly specifying the number of technical features indicated. Therefore, features defined with “first” and “second” can explicitly or implicitly include at least one of these features. In addition, the technical solutions between various embodiments can be combined with each other, but must be based on the ability of ordinary skilled in the art to achieve. When a combination of technical solutions is contradictory or impossible to achieve, it should be considered that such a combination of technical solutions does not exist and shall not fall within the scope of protection of the present disclosure.

The present disclosure proposes a sound producing unit 100. It is understood that the sound producing unit 100 is applied to electronic devices, which can be mobile phones, audio equipment, computers, headphones, watches, televisions, etc., without limitation. In this embodiment, the sound producing unit 100 uses a material with high magnetic conductivity to enhance the magnetic induction intensity of the magnetic circuit system 2 of the sound producing unit 100, thereby increasing the BL value, so that the magnetic circuit system 2 of the sound producing unit 100 can meet the magnetic field strength demands after thinning, effectively improving the acoustic performance and sound producing effect.

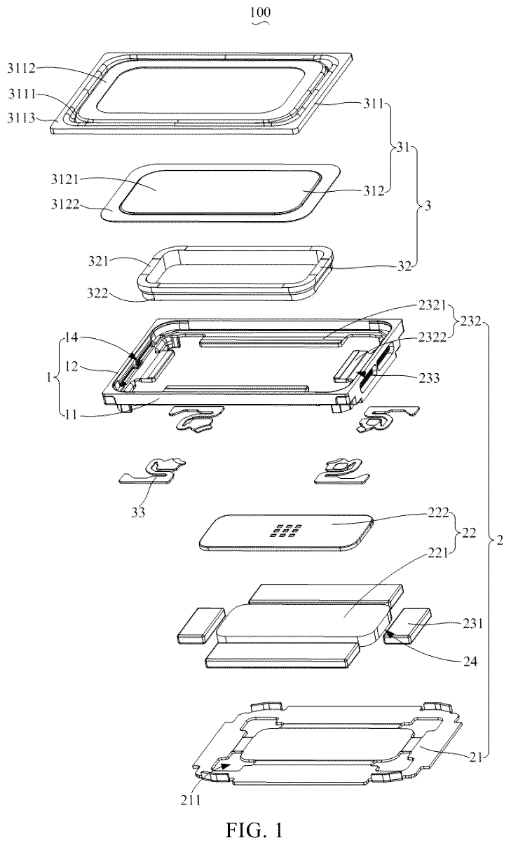

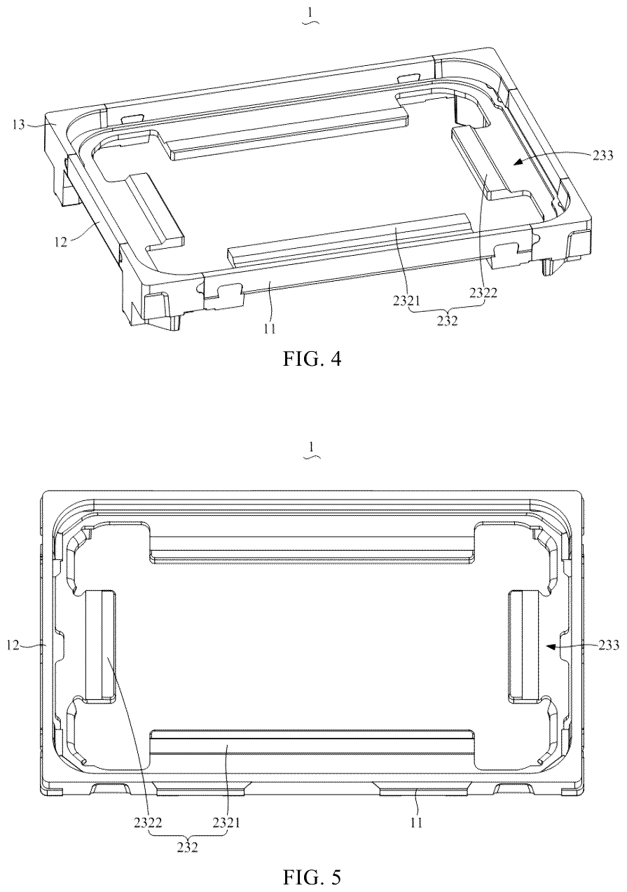

Please refer to FIG. 1 to FIG. 6. In an embodiment of the disclosure, the sound producing unit 100 includes a housing 1 and a magnetic circuit system 2. The housing 1 is at least in part composed of a cobalt alloy material, and the magnetic circuit system 2 is provided on the housing 1. The magnetic circuit system 2 includes a magnetic conducting yoke 21, a central magnetic part 22, and an edge magnetic part 23. The central magnetic part 22 and the edge magnetic part 23 are respectively provided on the magnetic conducting yoke 21, and the edge magnetic part 23 is provided on an outer side of the central magnetic part 22, and is connected to the housing 1.

In this embodiment, the housing 1 of the sound producing unit 100 is used to install, fix, support, and protect components such as the magnetic circuit system 2. That is, the housing 1 provides a mounting foundation for components such as the magnetic circuit system 2. It can be understood that the housing 1 can be a structure with a mounting cavity, such as a mounting shell, a casing, a frame, or a box. That is, the housing 1 defines a storage space, i.e., the housing 1 has a cavity, which is not limited here.

Alternatively, the housing 1 is a rectangular or square frame structure, with two opposing long edges and two opposing short edges, with two ends of the short edges being connected to the two long edges, and two ends of the long edges being connected to the two short edges, so that the housing 1 defines a containment cavity. Of course, the housing 1 can also be a circular or basin-shaped structure, which may adapt to different terminals or electronic devices.

It is understandable that the housing 1 can be a metal piece, an injection molded piece, or formed as an injection molding piece of a metal piece and a plastic piece integrated as a whole. In this embodiment, at least part of the structure of the housing 1 is composed of a cobalt alloy material. Alternatively, the housing 1 can be made entirely of a cobalt alloy material. Alternatively, the housing 1 can be injection molded with a cobalt alloy material and a plastic piece integrated as a whole. Alternatively, the housing 1 can be made of a cobalt alloy material and other metal materials to form an integrated structure, etc., which is not limited here.

In this embodiment, the cobalt alloy material is a material with high magnetic conductivity with a strong saturation magnetic induction intensity. With a given constant size, the greater the saturation magnetic induction intensity of the magnetic conducting material, the greater the BL value and the better the performance.

It is understandable that by providing the housing 1 to be at least in part composed of a cobalt alloy material, and thus providing the magnetic circuit system 2 on the housing 1, the central magnetic part 22 and the edge magnetic part 23 of the magnetic circuit system 2 are respectively placed on the magnetic conducting yoke 21, and the edge magnetic part 23 is provided on an outer side of the central magnetic part 22, and connected to the housing 1 with the edge magnetic part 23, so that the housing 1 made of a cobalt alloy material is connected to the edge magnetic part 23, thereby utilizing the high saturation magnetic induction intensity of the housing 1 to cooperate with the magnetic circuit system 2 in the sound producing unit 100, effectively meeting the magnetic field intensity demands of the magnetic circuit system 2, so that the sound producing unit 100 can effectively improve the magnetic induction intensity of the magnetic circuit system 2 under a given constant size, thereby enhancing the BL value, improving the acoustic performance and sound producing effect of the sound producing unit 100.

In this embodiment, by having at least part of the structure of the housing 1 being composed of a cobalt alloy material with high magnetic conductivity, the magnetic circuit system 2 in the sound producing unit 100 can meet the magnetic field strength demands after thinning.

In one embodiment, the cobalt alloy material of the housing 1 may be of a material grade of Co50 or Co27.

It should be noted that Co50 is a commonly used soft magnetic alloy material that has the capability to rapidly reverse its magnetic vector direction in a magnetic field. Co50 has high magnetic conductivity, low iron loss, and good thermal stability. Magnetic conductivity is one of the important performance indicators of soft magnetic alloys, which refers to the magnetic conductivity of materials under the action of a magnetic field. The higher the magnetic conductivity, the stronger the material's capability to respond to the magnetic field. Co27 is a soft magnetic alloy with high saturation and high Curie temperature. Co27 has good mechanical toughness, good ductility, and high saturation magnetic induction intensity. Compared to Co50 alloy, Co27 alloy has better gas permeability and does not exhibit the brittleness of Co50 alloy.

It is understandable that by having at least part of the structure of the housing 1 composed of a cobalt alloy material of Co50 or Co27, the housing 1 has a high magnetic conductivity. The edge magnetic part 23 of the magnetic circuit system 2 is connected to the housing 1 made of a cobalt alloy material, so as to utilize the high saturation magnetic induction intensity of the housing 1 to cooperate with the magnetic circuit system 2 to effectively meet the magnetic field intensity demands of the magnetic circuit system 2, so that the sound producing unit 100 in a given constant size can meet the magnetic field intensity demands after thinning of the magnetic circuit system 2, effectively improving the magnetic induction intensity of the magnetic circuit system 2, thereby enhancing the BL value, improving the acoustic performance and sound producing effect of the sound producing unit 100.

In one embodiment, the central magnetic part 22 includes a central magnetic steel 221 and a central magnetic conducting plate 222, and two opposite sides of the central magnetic steel 221 are respectively connected to the central magnetic conducting plate 222 and the magnetic conducting yoke 21. The edge magnetic part 23 includes an edge magnetic steel 231 and an edge magnetic conducting plate 232, and two opposite sides of the edge magnetic steel 231 are respectively connected to the edge magnetic conducting plate 232 and the magnetic conducting yoke 21. The central magnetic conducting plate 222 and/or the edge magnetic conducting plate 232 are composed of a cobalt alloy material.

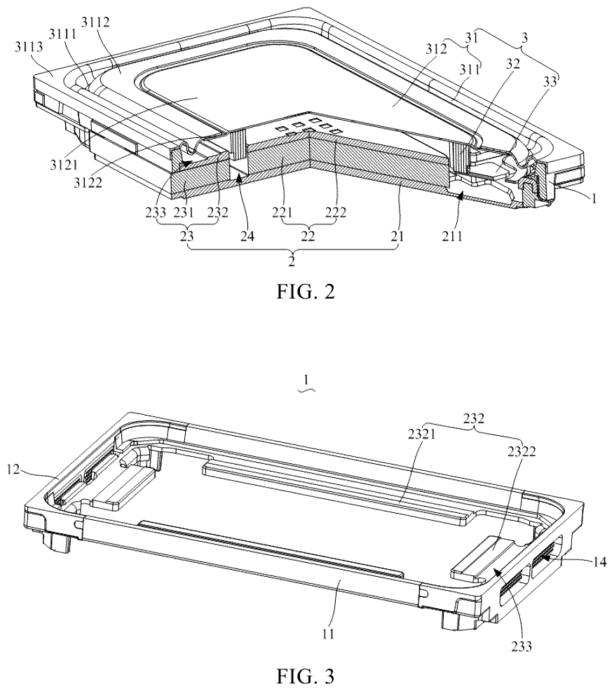

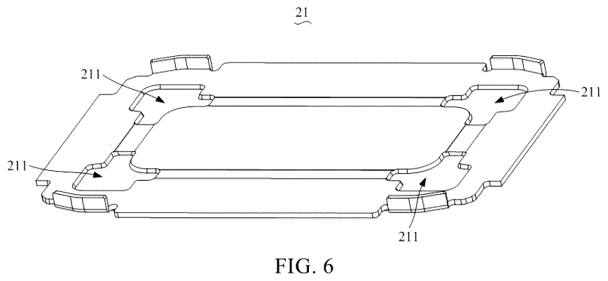

In this embodiment, as shown in FIG. 1, FIG. 2 and FIG. 6, the magnetic conducting yoke 21 can be selected as a magnetic flat plate or a magnetic basin frame and other structures, which are not limited here. The magnetic conducting yoke 21 is used to support and install the fixed central magnetic part 22 and the edge magnetic part 23. The magnetic circuit system 2 is fixedly connected to the housing 1 via the edge magnetic part 23. Optionally, the magnetic conducting yoke 21 is adhesively connected to the central magnetic part 22 and the edge magnetic part 23, and the edge magnetic part 23 is adhesively connected to the housing 1.

It is understandable that the central magnetic part 22 includes a central magnetic steel 221 and a central magnetic conducting plate 222 that are provided in a stacked way, and the central magnetic steel 221 is provided between the central magnetic conducting plate 222 and the magnetic conducting yoke 21. Optionally, the central magnetic conducting plate 222 can be a magnetic conducting flat plate structure. The structural profiles of the central magnetic steel 221 and the central magnetic conducting plate 222 are the same, and the central magnetic steel 221 and the central magnetic conducting plate 222 can be selected as a plate-like structure or a loop-like structure, which is not limited here. The edge magnetic part 23 includes an edge magnetic steel 231 and an edge magnetic conducting plate 232 that are provided in a stacked way, and the edge magnetic steel 231 is sandwiched between the edge magnetic conducting plate 232 and the magnetic conducting yoke 21. The edge magnetic steel 231 and the edge magnetic conducting plate 232 are located on an outer side of the central magnetic steel 221 and the central magnetic conducting plate 222, and are spaced apart to form a magnetic gap 24. Optionally, the edge magnetic steel 231 is a permanent magnet. The edge magnetic conducting plate 232 is a magnetic conducting flat plate.

It should be noted that the edge magnetic steel 231 and the edge magnetic conducting plate 232 can be selected as a loop structure, so that the edge magnetic steel 231 and the edge magnetic conducting plate 232 are provided surrounding an outer side of the central magnetic part 22. Of course, in other embodiments, there are provided a plurality of the edge magnetic steels 231 and a plurality of the edge magnetic conducting plates 232, and the plurality of edge magnetic steel 231 and the plurality of edge magnetic conducting plate 232 are in one-to-one correspondence, and the plurality of edge magnetic steel 231 and the plurality of edge magnetic conducting plate 232 are arranged spaced apart around the central magnetic part 22 to form a magnetic gap 24, which is not limited. Optionally, the edge magnetic steel 231 and the edge magnetic conducting plate 232 are identical in shape and structure.

Of course, in other embodiments, there may be a plurality of edge magnetic steel 231, which are arranged spaced apart and surround the central magnetic part 22. The edge magnetic steel 232 is in a loop structure, which is not limited here.

In this embodiment, by adopting cobalt alloy material for composing the central magnetic conducting plate 222 and/or the edge magnetic conducting plate 232, i.e., using high magnetic conducting material (cobalt alloy material) for composing the central magnetic conducting plate 222 and/or the edge magnetic conducting plate 232, it is possible to effectively improve the saturation magnetic induction intensity of the central magnetic conducting plate 222 and/or the edge magnetic conducting plate 232. Therefore, under a given constant size, the greater the saturation magnetic induction intensity of the central magnetic conducting plate 222 and/or the edge magnetic conducting plate 232, the greater the BL value and the better the performance. This enables the magnetic circuit system 2 to meet the magnetic field strength demands after thinning, effectively improving the saturation magnetic induction intensity of the magnetic conducting material, thereby enhancing the BL value, while improving acoustic performance and sound effect.

Alternatively, the central magnetic conducting plate 222 is composed of a cobalt alloy material; or, the edge magnetic conducting plate 232 is composed of a cobalt alloy material; or, both the central magnetic conducting plate 222 and the edge magnetic conducting plate 232 are composed of a cobalt alloy material, which is not limited here.

In one embodiment, the cobalt alloy material of the central magnetic conducting plate 222 is of a material grade of Co50 or Co27.

It should be noted that Co50 is a commonly used soft magnetic alloy material that has the capability to rapidly reverse its magnetic vector direction in a magnetic field. Co50 has high magnetic conductivity, low iron loss, and good thermal stability. Magnetic conductivity is one of the important performance indicators of soft magnetic alloys, which refers to the magnetic conductivity of materials under the action of a magnetic field. The higher the magnetic conductivity, the stronger the material's capability to respond to the magnetic field. Co27 is a soft magnetic alloy with high saturation and high Curie temperature. Co27 has good mechanical toughness, good ductility, and high saturation magnetic induction. Compared to Co50 alloy, Co27 alloy has better gas permeability and does not exhibit the brittleness of Co50 alloy.

It is understandable that by having the central magnetic conducting plate 222 composed of a cobalt alloy material of Co50 or Co27, the central magnetic conducting plate 222 has a high magnetic conductivity. The edge magnetic part 23 of the magnetic circuit system 2 is connected to the housing 1 made of a cobalt alloy material, so as to utilize the high saturation magnetic induction intensity of the housing 1, the high saturation magnetic induction intensity of the central magnetic conducting plate 222 to cooperate with the magnetic circuit system 2 to effectively meet the magnetic field strength demands of the magnetic circuit system 2, so that the sound producing unit 100 can meet the magnetic field strength demands under a given constant size, that is, the magnetic circuit system 2 in the sound producing unit 100 can meet the magnetic field strength demands after thinning of the magnetic circuit system 2, effectively improving the magnetic induction intensity of the magnetic circuit system 2, thereby enhancing the BL value, improving the acoustic performance and sound producing effect of the sound producing unit 100.

In one embodiment, the cobalt alloy material of the edge magnetic conducting plate 232 is of a material grade of Co50 or Co27.

It should be noted that Co50 is a commonly used soft magnetic alloy material that has the capability to rapidly reverse its magnetic vector direction in a magnetic field. Co50 has high magnetic conductivity, low iron loss, and good thermal stability. Magnetic conductivity is one of the important performance indicators of soft magnetic alloys, which refers to the magnetic conductivity of materials under the action of a magnetic field. The higher the magnetic conductivity, the stronger the material's capability to respond to the magnetic field. Co27 is a soft magnetic alloy with high saturation and high Curie temperature. Co27 has good mechanical toughness, good ductility, and high saturation magnetic induction. Compared to Co50 alloy, Co27 alloy has better gas permeability and does not exhibit the brittleness of Co50 alloy.

It is understandable that by having the edge magnetic conducting plate 232 composed of a cobalt alloy material of Co50 or Co27, the edge magnetic conducting plate 232 has a high magnetic conductivity. The edge magnetic part 23 of the magnetic circuit system 2 is connected to the housing 1 made of a cobalt alloy material, so as to utilize the high saturation magnetic induction intensity of the housing 1, the high saturation magnetic induction intensity of the edge magnetic conducting plate 232 to cooperate with the magnetic circuit system 2 to effectively meet the magnetic field strength demands of the magnetic circuit system 2, so that the sound producing unit 100 in a given constant size can meet the magnetic field strength demands, that is, after thinning of the magnetic circuit system 2 in the sound producing unit 100, which can effectively improve the magnetic induction intensity of the magnetic circuit system 2, thereby enhancing the BL value, improving the acoustic performance and sound effect of the sound producing unit 100.

Alternatively, the material grade of the cobalt alloy material of the central magnetic conducting plate 222 is Co50 or Co27, and the material grade of the cobalt alloy material of the edge magnetic conducting plate 232 is Co50 or Co27. It can be understood that by using the housing 1, the central magnetic conducting plate 222, and the edge magnetic conducting plate 232 composed of a cobalt alloy material of Co50 or Co27, the housing 1, the central magnetic conducting plate 222, and the edge magnetic conducting plate 232 have high magnetic conductivity. The edge magnetic part 23 of the magnetic circuit system 2 is connected to the housing 1 made of a cobalt alloy material, so that the high saturation magnetic induction intensity of the housing 1, the central magnetic conducting plate 222, and the edge magnetic conducting plate 232 can cooperate with the central magnetic steel 221 and the edge magnetic steel 231 of the magnetic circuit system 2 to effectively meet the magnetic field intensity demands of the magnetic circuit system 2, so that the sound producing unit 100 can meet the magnetic field intensity demands under a given constant size, that is, after thinning the magnetic circuit system 2 in the sound producing unit 100, effectively improving the saturation magnetic induction intensity of the magnetic conducting material, thereby enhancing BL value, improving acoustic performance and sound producing effect.

In one embodiment, the magnetic conductivity of the cobalt alloy material in any one of the housing 1, the central magnetic conducting plate 222, and the edge magnetic conducting plate 232 is no less than 5200 Gs/Oe. It can be understood that such a setting can utilize the housing 1, the central magnetic conducting plate 222, and the edge magnetic conducting plate 232 with strong magnetic conductivity, effectively ensuring that the magnetic circuit system 2 can meet the magnetic field strength demands after thinning, so as to achieve the thin design of the sound producing unit 100.

In one embodiment, the saturation magnetic induction intensity B of the cobalt alloy material in any one of the housing 1, the central magnetic conducting plate 222, and the edge magnetic conducting plate 232 is no less than 2.25 T. It can be understood that such a setting can utilize the cobalt alloy material of the housing 1, the central magnetic conducting plate 222, and the edge magnetic conducting plate 232 with a high saturation magnetic induction intensity, effectively ensuring that the magnetic circuit system 2 can meet the magnetic field strength demands after thinning, so as to achieve the thin design of the sound producing unit 100.

In one embodiment, the thickness of the edge magnetic conducting plate 232 is no greater than 0.23 mm. It is understood that the thickness of the edge magnetic conducting plate 232 is the thickness of the edge magnetic conducting plate 232 along the vibration direction of the diaphragm 311 of the sound producing unit 100, that is, along the direction perpendicular to the plane of the edge magnetic conducting plate 232. In this embodiment, the edge magnetic conducting plate 232 can be a regular plate structure (that is, the thicknesses of each part of the edge magnetic conducting plate 232 are the same), or an irregular plate structure (that is, the thicknesses of each part of the edge magnetic conducting plate 232 are not all the same).

Alternatively, the maximum thickness of the edge magnetic conducting plate 232 is no greater than 0.23 mm. It can be understood that since the edge magnetic conducting plate 232 is made of a cobalt alloy material, it can effectively enhance the magnetic induction intensity of the magnetic circuit system 2. When the thickness of the edge magnetic conducting plate 232 is less than or equal to 0.23 mm, it can meet the magnetic field intensity demands of the magnetic circuit system 2, which can effectively realize the thin design of the sound producing unit 100.

In one embodiment, the thickness of the central magnetic conducting plate 222 is no greater than 0.23 mm. It is understood that the thickness of the central magnetic conducting plate 222 is the thickness of the central magnetic conducting plate 222 along the vibration direction of the diaphragm 311 of the sound producing unit 100, that is, along the direction perpendicular to the plane of the central magnetic conducting plate 222. In this embodiment, the central magnetic conducting plate 222 can be a regular plate structure (that is, the thicknesses of each part of the central magnetic conducting plate 222 are the same), or an irregular plate structure (that is, the thicknesses of each part of the central magnetic conducting plate 222 are not all the same).

Alternatively, the maximum thickness of the central magnetic conducting plate 222 is no greater than 0.23 mm. It can be understood that, due to the use of a cobalt alloy material for the central magnetic conducting plate 222, the magnetic induction intensity of the magnetic circuit system 2 can be effectively improved. When the thickness of the central magnetic conducting plate 222 is less than or equal to 0.23 mm, it can meet the magnetic field intensity demands of the magnetic circuit system 2, and can effectively achieve the thin design of the sound producing unit 100.

In one embodiment, the thickness of the magnetic conducting yoke 21 is no greater than 0.23 mm. It is understood that the thickness of the magnetic conducting yoke 21 is the thickness of the magnetic conducting yoke 21 along the vibration direction of the diaphragm 311 of the sound producing unit 100, that is, along the direction perpendicular to the plane of the magnetic conducting yoke 21. In this embodiment, the magnetic conducting yoke 21 can be a regular plate structure (that is, the thicknesses of each part of the magnetic conducting yoke 21 are the same), or an irregular plate structure (that is, the thicknesses of each part of the magnetic conducting yoke 21 are not all the same).

Alternatively, the maximum thickness of the magnetic conduction yoke 21 is no greater than 0.23 mm. It can be understood that since the magnetic conduction yoke 21 is made of a cobalt alloy material, it can effectively enhance the magnetic induction intensity of the magnetic circuit system 2. When the thickness of the magnetic conduction yoke 21 is less than or equal to 0.23 mm, it can meet the magnetic field intensity demands of the magnetic circuit system 2, and can effectively achieve the thin design of the sound producing unit 100.

In this embodiment, optionally, the maximum thickness of the edge magnetic conducting plate 232 is no greater than 0.23 mm, the maximum thickness of the central magnetic conducting plate 222 is no greater than 0.23 mm, and the maximum thickness of the magnetic conducting yoke 21 is no greater than 0.23 mm, which are not limited herein.

In an embodiment, the sound producing unit 100 further includes a vibration system 3, which includes a diaphragm 311, the diaphragm 311 including: a corrugated rim 3111, an inner fixing part 3112 provided on an inner side of corrugated rim 3111, and an outer fixing parts 3113 provided on an outer side of the corrugated rim 3111. The outer fixing part 3113 is connected to the housing 1, the corrugated rim 3111 is recessed towards the edge magnetic conducting plate 232, the edge magnetic conducting plate 232 is provided with a first avoidance slot 233 which is opposite to the corrugated rim 3111 and extends away from the diaphragm 311, the depth of the first avoidance slot 233 being no greater than 0.1 mm.

In this embodiment, as shown in FIG. 1 to FIG. 5, the housing 1 is provided as a frame and forms a cavity with two ends opened. The magnetic circuit system 2 is connected to the housing 1 through an edge magnetic conducting plate 232 to cover an opening at one end of the cavity. The vibration system 3 is connected to the housing 1 through a diaphragm 311 to cover the opening at the other end of the cavity, so that the housing 1, the magnetic circuit system 2 and the vibration system 3 enclose a vibration space. It can be understood that the vibration system 3 also includes a voice coil 32 located in the vibration space. One end of the voice coil 32 is connected to the diaphragm 311, and the other end of the voice coil 32 is suspended in the magnetic gap 24 of the magnetic circuit system 2.

It should be noted that by introducing the current of an external circuit into the voice coil 32, using the voice coil 32 to transfer the electrical energy into the magnetic gap 24 of the magnetic circuit system 2, the magnetic field generated by the magnetic circuit system 2 converts the electrical energy into mechanical energy, causing the voice coil 32 to vibrate and drive the diaphragm 311 to vibrate and produce sound, further converting mechanical energy into acoustic energy. It can be understood that after receiving the external alternating current signal, the voice coil 32 provided in the magnetic gap will undergo reciprocal cutting motion of the magnetic field lines under the driving force of the magnetic field of the magnetic circuit system 2, driving the diaphragm 311 of the vibration system 3 to vibrate and produce sound, thereby effectively improving the BL value of the sound producing unit 100.

In this embodiment, the corrugated rim 3111 of the diaphragm 311 is provided surrounding the inner fixing part 3112, and the outer fixing part 3113 is provided surrounding the corrugated rim 3111 and located on an outer side of the corrugated rim 3111. Optionally, the inner fixing part 3112, the corrugated rim 3111, and the outer fixing part 3113 of the diaphragm 311 are an integrally formed structure. The diaphragm 311 is connected and fixed to the housing 1 of the sound producing unit 100 through the outer fixing part 3113 to improve the connection stability and sealing of the housing 1 and the diaphragm 311.

It is understandable that in order to increase the effective vibration area of the diaphragm 311, the outer fixing part 3113 can be formed by extending downward or upward from the outer side of the corrugated rim 3111, or by extending downward or upward from the outer side of the outer fixing part 3113 to form an extension part so that the outer fixing part 3113 is connected and fixed to the inner side wall or outer side wall of the housing 1.

In this embodiment, as shown in FIG. 1 to FIG. 5, the corrugated rim 3111 is recessed towards the edge magnetic conducting plate 232, thereby reducing the overall vibration height of the vibration system 3, which can help achieve the thin design of the sound producing unit 100. By providing, on the edge magnetic conducting plate 232, a first avoidance slot 233 opposite to the corrugated rim 3111 and extending away from the diaphragm 311, the depth of the first avoidance slot 233 is made to be no greater than 0.1 mm, which can effectively utilize the first avoidance slot 233 of the edge magnetic conducting plate 232 to provide an avoidance space for the corrugated rim 3111 of the diaphragm 311 during vibration, preventing the corrugated rim 3111 from colliding with the edge magnetic conducting plate 232 and affecting the sound producing effect; at the same time, provision of the first avoidance slot 233 can also reduce the weight of the magnetic circuit system 2. Moreover, because the edge magnetic conducting plate 232 is made of a cobalt alloy material, by setting the depth of the first avoidance slot 233 no greater than 0.1 mm, it is possible to reduce the processing difficulty of the first avoidance slot 233 while meeting the demands for avoiding the corrugated rim 3111, thus saving production cost.

It is understandable that the first avoidance slot 233 is formed by the edge magnetic conducting plate 232 recessing in a direction away from the diaphragm 311. The depth of the first avoidance slot 233 is the height along the vibration direction of the diaphragm 311. Alternatively, the depth of the first avoidance slot 233 is 0.01 mm, 0.02 mm, 0.03 mm, 0.04 mm, 0.05 mm, 0.06 mm, 0.07 mm, 0.08 mm, 0.09 mm, 0.1 mm, etc., which is not limited here.

In one embodiment, the magnetic conducting yoke 21 is composed of a cobalt alloy material. It is understood that by setting the magnetic conducting yoke 21 to be composed of a cobalt alloy material, that is, using a high magnetic conducting material (cobalt alloy material) for the magnetic conducting yoke 21, the saturation magnetic induction intensity of the magnetic conducting yoke 21 can be effectively increased. Therefore, under a given constant size, the larger the saturation magnetic induction intensity of the magnetic conducting yoke 21, the larger the BL value and the better the performance. This enables the magnetic circuit system 2 to meet the magnetic field strength demands after thinning, effectively improving the magnetic induction intensity of the magnetic circuit system 2, thereby enhancing the BL value and improving the acoustic performance and sound effect of the sound producing unit 100.

Alternatively, the cobalt alloy in the magnetic conducting yoke 21 is of a material grade of Co50 or Co27. It should be noted that Co50 is a commonly used soft magnetic alloy material that can rapidly reverse its magnetic vector direction in a magnetic field. Co50 has high magnetic conductivity, low iron loss, and good thermal stability. Magnetic conductivity is one of the important performance indicators of soft magnetic alloys, which refers to the magnetic conductivity of materials under the action of a magnetic field. The higher the magnetic conductivity, the stronger the material's capability to respond to the magnetic field. Co27 is a soft magnetic alloy with high saturation and high Curie temperature. Co27 has good mechanical toughness, good ductility, and high saturation magnetic induction intensity. Compared to Co50 alloy, Co27 alloy has better gas permeability and does not exhibit the brittleness of Co50 alloy.

It is understandable that by using a cobalt alloy material composed of Co50 or Co27 for the magnetic conducting yoke 21, the magnetic conducting yoke 21 has a high magnetic conductivity. The edge magnetic part 23 of the magnetic circuit system 2 is connected to the housing 1 made of a cobalt alloy material, so as to utilize the high saturation magnetic induction intensity of the housing 1 and the high saturation magnetic induction intensity of the magnetic conducting yoke 21 to cooperate with the central magnetic steel 221 and the edge magnetic steel 231 of the magnetic circuit system 2 to effectively meet the magnetic field strength demands of the magnetic circuit system 2, so that the sound producing unit 100 can meet the magnetic field strength demands under a given constant size, that is, after thinning the magnetic circuit system 2 in the sound producing unit 100, effectively improving the magnetic induction intensity of the magnetic circuit system 2, thereby enhancing the BL value, improving the acoustic performance and sound producing effect of the sound producing unit 100.

In one embodiment, the magnetic conductivity of the cobalt alloy material of the magnetic conducting yoke 21 is no less than 5200 Gs/Oe. It is understood that such a setting can utilize the high magnetic conductivity of the magnetic conducting yoke 21 to effectively ensure that the magnetic circuit system 2 can meet the magnetic field strength demands after thinning, so as to achieve the thin design of the sound producing unit 100. In this embodiment, optionally, the magnetic conductivity of the cobalt alloy material in any one of the housing 1, the magnetic conducting yoke 21, the central magnetic conducting plate 222, and the edge magnetic conducting plate 232 is no less than 5200 Gs/Oe.

In one embodiment, the saturation magnetic induction intensity B of the cobalt alloy material of the magnetic conduction yoke 21 is no less than 2.25 T. It can be understood that such a setting can utilize the high saturation magnetic induction intensity of the cobalt alloy material of the magnetic conduction yoke 21 to effectively ensure that the magnetic circuit system 2 can meet the magnetic field strength demands after thinning, so as to achieve the thin design of the sound producing unit 100.

In one embodiment, the edge magnetic part 23 and the central magnetic part 22 are arranged spaced apart to form a magnetic gap 24. The sound producing unit 100 also includes a vibration system 3, which includes a diaphragm assembly 31, a voice coil 32, and a damper assembly 33. The outer circumference of the diaphragm assembly 31 is fixed to the housing 1. The first end 321 of the voice coil 32 is connected to the diaphragm assembly 31, and the second end 322 of the voice coil 32 is inserted into the magnetic gap 24. The two ends of the damper assembly 33 are respectively connected to the second end 322 of the voice coil 32 and the housing 1. The magnetic conducting yoke 21 is provided with a second avoidance slot 211 opposite to the damper assembly 33, which extends away from the damper assembly 33. The depth of the second avoidance slot 211 is between 0.05 mm and 0.15 mm.

In this embodiment, as shown in FIGS. 1 to 6, the vibration system 3 is fixed to the housing 1 along the outer circumference of the diaphragm assembly 31, so that the diaphragm assembly 31 is provided opposite to and spaced apart from the magnetic circuit system 2. The first end 321 of the voice coil 32 is connected to the diaphragm assembly 31, and the second end 322 of the voice coil 32 is inserted into the magnetic gap 24, so that the current of the external circuit is introduced into the voice coil 32, and the electric energy is transmitted to the magnetic gap 24 of the magnetic circuit system 2 by using the voice coil 32, so that the magnetic field generated by the magnetic circuit system 2 converts the electric energy into mechanical energy, thereby causing the voice coil 32 to vibrate and driving the diaphragm assembly 31 to achieve vibration sound producing, further converting mechanical energy into acoustic energy.

Understandably, after receiving an external varying AC signal, the voice coil 32 provided in the magnetic gap performs reciprocal cutting motion of the magnetic field lines driven by the magnetic field force of the magnetic circuit system 2, driving the diaphragm assembly 31 of the vibration system 3 to vibrate and produce sound.

In this embodiment, by providing the damper assembly 33, the two ends of the damper assembly 33 are respectively connected to the second end 322 of the voice coil 32 and the housing 1, thereby using the damper assembly 33 to balance and stabilize the vibration of the voice coil 32 driving the diaphragm assembly 31, avoiding the phenomenon of vibration or polarization of the diaphragm assembly 31 driven by the voice coil 32.

It is understandable that the damper assembly 33 can be a damper and/or an auxiliary diaphragm and other structures. Alternatively, the damper assembly 33 can be a damper. In this embodiment, the damper includes a first fixing part, a second fixing part, and an elastic part connected between the first fixing part and the second fixing part. The first fixing part is connected to the housing 1, and the second fixing part is connected to the voice coil 32.

Alternatively, the damper is made of PI material, which can make the damper thinner to save material and installation space, thereby effectively increasing the volume of the magnetic circuit system 2 and improving the BL value of the product.

Alternatively, the damper can be a single-layer structure. Of course, in other embodiments, the damper can also be a multi-layer structure to form a complex structure, which is not limited here.

Alternatively, the damper may consist of one or more layers of material. When using a single layer of material for the damper, the material hardness and thickness can be selected to match the length of the elastic part. In contrast, when using multiple layers of material for the damper, each layer can be selected to have a lower elastic modulus. Due to the flexible design of the damper, it is beneficial to choose a lightweight design that improves product performance.

In order to further increase the elongation of the damper, in one embodiment, the elastic part includes two elastic arms and a bending part connecting the two elastic arms. The bending part and the two elastic arms enclose an elastic space, and each of the first fixing part and the second fixing part connects to a respective end of each of the two elastic arms distant to the bending part. It can be understood that such a setting can effectively increase the arm length of the elastic part, improving the stretchability and elastic deformation performance of the damper. It should be noted that when the damper is set in a stationary state, the elastic arm of the damper can be made very short, so that there is more space for expanding the size of the magnet in the magnetic circuit system 2, improving product performance.

In one embodiment, there are provided a plurality of dampers, and the magnetic circuit system 2 is provided with multiple communication gaps in communication with the magnetic gap 24. Each damper is arranged corresponding to a communication gap. In this embodiment, the damper includes a first fixing part, a second fixing part, and an elastic part connected between the first fixing part and the second fixing part. The first fixing part is connected to the housing 1, and the second fixing part is connected to the side of the voice coil 32 facing away from the diaphragm 311.

It is understandable that the anchor plate can be a large integral structure, and the first fixing part can be a loop structure connected to the housing 1. The second fixing part is connected to the end of the voice coil 32 facing away from the diaphragm 311, and the second fixing part is connected to the first fixing part via the elastic part. When the voice coil 32 vibrates, the second fixing part drives the elastic part to deform, so as to avoid the voice coil 32 driving the diaphragm 311 to oscillate or polarize.

Of course, in other embodiments, the dampers may also be multiple small components, for example, the dampers include two or four of them. When there are two of the dampers, the two dampers are symmetrically arranged and connected to the two short axes or two long axes of the housing 1, which is not limited here. When there are four of the dampers, the four dampers are respectively arranged at the four corner positions of the housing 1 to ensure symmetry, thereby ensuring the balance of the vibration of the voice coil 32 of the sound producing unit 100. Alternatively, there are four dampers, and the four dampers are arranged corresponding to the four communication gaps of the magnetic circuit system 2.

In this embodiment, by providing a second avoidance slot 211 on the magnetic conducting yoke 21 that is opposite to the damper assembly 33, the second avoidance slot 211 extends away from the damper assembly 33, and the depth of the second avoidance slot 211 is between 0.05 mm and 0.15 mm. This arrangement can effectively utilize the second avoidance slot 211 of the magnetic conducting yoke 21 to provide avoidance space for the damper assembly 33 during vibration. At the same time, the provision of the second avoidance slot 211 can reduce the weight of the magnetic circuit system 2. Moreover, because the magnetic conducting yoke 21 is made of a cobalt alloy material, by setting the depth of the second avoidance slot 211 between 0.05 mm and 0.15 mm, it is possible to reduce the processing difficulty of the second avoidance slot 211 while meeting the demands for avoidance of the damper assembly 33, thereby saving production costs.

It is understandable that the second avoidance slot 211 is formed by the magnetic conducting yoke 21 recessing in a direction away from the damper assembly 33. The depth of the second avoidance slot 211 is the height along the vibration direction of the diaphragm 311. Alternatively, the depth of the second avoidance slot 211 can be 0.05 mm, 0.06 mm, 0.07 mm, 0.08 mm, 0.09 mm, 0.1 mm, 0.11 mm, 0.12 mm, 0.13 mm, 0.14 mm, 0.15 mm, etc., which is not limited here.

In an embodiment, the diaphragm assembly 31 includes a diaphragm 311 and a vibrating plate 312. The outer circumference of the diaphragm 311 is connected to the housing 1, and the vibrating plate 312 is connected to the diaphragm 311 and to the first end 321 of the voice coil 32. The vibrating plate 312 includes a main body part 3121 and a beading part 3122 provided on the outer circumference of the main body part 3121. The beading part 3122 is bent towards the direction closer to the magnetic circuit system 2 relative to the main body part 3121. The inner side of the diaphragm 311 is provided with an inner fixing part 3112, which is connected to the beading part 3122, and the top surface of the inner fixing part 3112 and the main body part 3121 are located in the same plane.

In this embodiment, as shown in FIG. 1 and FIG. 2, a hollow hole is provided in the center of the diaphragm 311, and the vibrating plate 312 is connected to the inner fixing part 3112 in the center of the diaphragm 311 and covers the hollow hole. It can be understood that by providing a hollow hole in the center of the diaphragm 311, the overall weight of the diaphragm 311 can be effectively reduced. Optionally, a hollow hole can be provided in the central position of the diaphragm 311, and the hollow hole can be a through hole, a hollow hole, or an opening. Optionally, there can be one or more hollow holes, which is not limited here.

In order to strengthen the structural strength of the diaphragm 311 and avoid the contraction and increased deformation of the diaphragm 311 during vibration, a vibrating plate 312 is arranged in the center of the diaphragm 311, which is connected to the inner fixing part 3112 in the center of the diaphragm 311 and covers the hollow hole, thus strengthening the structural strength of the diaphragm 311 and meeting the modulus and strength demands of the diaphragm 311.

In this embodiment, by providing the vibrating plate 312 with a main body part 3121 and a corrugated rim 3122 provided on the outer circumference of the main body part 3121, the corrugated rim 3122 is bent towards the direction of the magnetic circuit system 2 relative to the main body part 3121, and the inner fixing part 3112 on an inner side of the diaphragm 311 is connected to the corrugated rim 3122. The inner fixing part 3112 and the top surface of the main body part 3121 are located in the same plane. This can effectively reduce the height of the sound producing unit 100 in the vibration direction, thereby achieving a thinner design.

Alternatively, the diaphragm 311 is made of rubber material, which has better temperature resistance and higher damping than conventional thermoplastic materials such as PEEK, TPU, TPEE, etc. The sound producing unit 100 using a rubber diaphragm 311 can meet the demands of high power and high temperature resistance for products.

In one embodiment, the housing 1 includes a first edge part 11 and a second edge part 12 in head-to-tail connection to each other. The first edge part 11 is formed as a cobalt alloy material piece, and the second edge part 12 is formed as a plastic material piece. The second edge part 12 is provided with a sound hole 14 in communication with an acoustic cavity inside the housing 1. The housing 1 further includes a mesh assembly that covers the sound hole 14. The mesh assembly is adhesively connected to the second edge part 12 or integrally molded with it.

In this embodiment, as shown in FIGS. 1 to 3 and FIG. 5, the housing 1 can be optionally provided as a rectangular or square frame. The housing 1 includes two first edge parts 11 and two second edge parts 12, which are provided in alternation and are in head-to-tail connection to form a frame structure. Optionally, the first edge parts 11 are formed as cobalt alloy material pieces, that is, the first edge parts 11 are composed of a cobalt alloy material, and the second edge parts 12 are formed as plastic material pieces. Optionally, the cobalt alloy material of the first edge parts 11 is of a material grade of Co50 or Co27.

It is understandable that the first edge 11 and the second edge 12 of the housing 1 are an integrated injection molding structure. The first edge 11 of the housing 1 is made of a cobalt alloy material, which is a material with high magnetic conductivity with high saturation magnetic induction intensity. With a given constant size, the higher the saturation magnetic induction intensity of the magnetic conducting material, the greater the BL value and the better the performance.

In this embodiment, as shown in FIG. 1 and FIG. 3, by setting the second edge part 12 as a plastic material piece, it is convenient to open a sound hole 14 in the second edge part 12 in communication with the internal sound cavity of the housing 1, and to provide a mesh assembly that covers the sound hole 14, so that the mesh assembly is adhered to the second edge part 12 or integrally molded with it, making assembly easier. Such a setting can not only produce sound through the sound hole 14, but also effectively prevent sound adsorbing particles filled in the rear sound cavity from entering the interior of the sound emitting unit 100 when the sound emitting unit 100 is installed in a module housing or an equipment housing or a metal BOX. Optionally, the mesh assembly can be a mesh, a metal isolation gas-permeable film, or other structures, which are not limited here.

In one embodiment, the edge magnetic part 23 includes an edge magnetic steel 231 and an edge magnetic conducting plate 232. Two opposite sides of the edge magnetic steel 231 are respectively connected to the edge magnetic conducting plate 232 and the magnetic conducting yoke 21. The edge magnetic conducting plate 232 includes a first edge magnetic conducting plate 2321 located on the first edge part 11 and a second edge magnetic conducting plate 2322 located on the second edge part 12. The first edge magnetic conducting plate 2321 and the first edge part 11 are formed as an integral molding piece.

In this embodiment, as shown in FIGS. 1 to 3, the edge magnetic conducting plate 232 of the edge magnetic part 23 includes a first edge magnetic conducting plate 2321 and a second edge magnetic conducting plate 2322, wherein the first edge magnetic conducting plate 2321 is connected to the first edge part 11, and the second edge magnetic conducting plate 2322 is connected to the second edge part 12.

Alternatively, the first edge magnetic conducting plate 2321 and the first edge 11 can be formed as an integral molding piece, which not only simplifies the structural arrangement of the housing 1 and the first edge magnetic conducting plate 2321, but also improves the connection stability. Of course, in other embodiments, the first edge magnetic conducting plate 2321 and the first edge 11 can also be connected by welding or adhesive connection, which is not limited here.

In this embodiment, the first edge magnetic conducting plate 2321 and the first edge part 11 are composed of a cobalt alloy material, so that the first edge magnetic conducting plate 2321 and the first edge part 11 are provided as an integrated molding part to simplify the processing steps. It can be understood that the second edge magnetic conducting plate 2322 is composed of a cobalt alloy material, and the second edge part 12 is formed as a plastic material piece. The second edge magnetic conducting plate 2322 and the second edge part 12 can be integrally molded. Of course, in other embodiments, adhesive fixing connection can also be used, which is not limited here.

In one embodiment, the housing 1 includes a first edge part 11, a second edge part 12, and a connecting part 13. The intersection of the first edge part 11 and the second edge part 12 is formed as a corner, and the connecting part 13 is located at the corner and connected to the first edge part 11 and the second edge part 12, respectively. The connecting part 13 is formed as a plastic material piece, and the first edge part 11 and the second edge part 12 are formed as cobalt alloy material pieces.

In this embodiment, as shown in FIG. 4, the housing 1 can be optionally provided as a rectangular or square frame. The housing 1 includes two first edge parts 11 and two second edge parts 12 that are alternately arranged, and are connected by connecting parts 13 at the corners where the first edge parts 11 and the second edge parts 12 intersect. Optionally, the connecting parts 13 are formed as plastic material pieces, and the first edge parts 11 and the second edge parts 12 are formed as cobalt alloy material pieces, that is, the first edge parts 11 and the second edge parts 12 are composed of a cobalt alloy material. Optionally, the cobalt alloy material of the first edge parts 11 and the second edge parts 12 is of the material grade of Co50 or Co27.

It is understandable that the first edge part 11 and the second edge part 12 of the housing 1 are integrally molded via the connecting part 13. The first edge part 11 and the second edge part 12 of the housing 1 are composed of a cobalt alloy material, which is a high magnetic conductivity material with high saturation magnetic induction intensity. Under a given constant size, the larger the saturation magnetic induction intensity of the magnetic conductivity material, the greater the BL value and the better the performance. Moreover, since the housing 1 is generally formed into a rectangular or square structure, by providing a connecting part 13 made of plastic material at its corner, the connecting part 13 plays a role in connecting the first edge part 11 and the second edge part 12 composed of a cobalt alloy material, thereby reducing the processing difficulty of the housing 1, and also increasing the composition of a cobalt alloy material of the housing 1, improving the magnetic field strength of the magnetic circuit system 2.

In one embodiment, the edge magnetic part 23 includes an edge magnetic steel 231 and an edge magnetic conducting plate 232. Two opposite sides of the edge magnetic steel 231 are respectively connected to the edge magnetic conducting plate 232 and the magnetic conducting yoke 21. The edge magnetic conducting plate 232 includes a first edge magnetic conducting plate 2321 located on the first edge part 11 and a second edge magnetic conducting plate 2322 located on the second edge part 12. The first edge magnetic conducting plate 2321 and the first edge part 11 are formed as an integral molding piece, and the second edge magnetic conducting plate 2322 and the second edge part 12 are formed as an integral molding piece.

In this embodiment, as shown in FIG. 1, FIG. 2 and FIG. 4, the edge magnetic conducting plate 232 of the edge magnetic part 23 includes a first edge magnetic conducting plate 2321 and a second edge magnetic conducting plate 2322. The first edge magnetic conducting plate 2321 is connected to the first edge part 11, and the second edge magnetic conducting plate 2322 is connected to the second edge part 12. The first edge magnetic conducting plate 2321 and the first edge part 11 are formed as an integral molding piece, and the second edge magnetic conducting plate 2322 and the second edge part 12 are formed as an integral molding piece. This can simplify the structural arrangement of the housing 1 and the first and second edge magnetic conducting plates 2321 and 2322, and also facilitate improved connection stability. Of course, in other embodiments, the first edge magnetic conducting plate 2321 and the first edge part 11 can also be connected by welding or adhesive connection, and the second edge magnetic conducting plate 2322 and the second edge part 12 can also be connected by welding or adhesive connection, which is not limited here.

In this embodiment, the first edge magnetic conducting plate 2321, the second edge magnetic conducting plate 2322, the first edge part 11, and the second edge part 12 are composed of a cobalt alloy material. In this way, the first edge magnetic conducting plate 2321 and the first edge part 11 are provided as an integrated molding piece, and the second edge magnetic conducting plate 2322 and the second edge part 12 are provided as an integrated molding piece, which simplifies the assembly process and improves assembly efficiency.

In one embodiment, the height of the sound producing unit 100 is no greater than 1.8 mm.

It is understandable that the height of the sound producing unit 100 is set to be no greater than 1.8 mm, thereby effectively realizing the thin design of the sound producing unit 100. In this embodiment, the height of the sound producing unit 100 is the height along the vibration direction of the diaphragm 311 or the height along the direction perpendicular to the top surface of the vibrating plate 312. For example, the sound producing unit 100 includes a vibration system 3 and a magnetic circuit system 2. The upper surface of the diaphragm assembly 31 of the vibration system 3 is the upper surface of the sound producing unit 100, and the bottom surface of the magnetic circuit system 2 is the lower surface of the sound producing unit 100. Then, the height of the sound producing unit 100 is the spacing between the upper surface of the diaphragm assembly 31 and the bottom surface of the magnetic circuit system 2.

The present disclosure also proposes an electronic device comprising the above-mentioned sound producing unit 100. The specific structure of the sound producing unit 100 is described in the aforementioned embodiments. Since the electronic device adopts all the technical solutions of all the aforementioned embodiments, it has at least all the advantages brought by the technical solutions of the aforementioned embodiments, which are not repeated here.

In this embodiment, the electronic device also includes a device housing, and the sound producing unit 100 is provided in the device housing. It is understood that the electronic device can be a mobile phone, audio, computer, headset, watch, or television, etc., without limitation.

The above descriptions are only optional embodiments of the present disclosure, and do not limit the scope of the present disclosure. Any equivalent structural transformation made utilizing the content of the description and drawings of the present disclosure, or directly/indirectly applications in other related technical fields, shall fall within the scope of patent protection of the present disclosure.

1. A sound producing unit, comprising:
a housing, comprising a cobalt alloy material; and
a magnetic circuit system provided on the housing, the magnetic circuit system comprising a magnetic conducting yoke, a central magnetic part, and an edge magnetic part, wherein the central magnetic part and the edge magnetic part are respectively provided on the magnetic conducting yoke, and the edge magnetic part is provided on an outer side of the central magnetic part and connected to the housing.

2. The sound producing unit of claim 1, wherein the cobalt alloy material comprises a material grade of Co₅₀ or Co₂₇.

3. The sound producing unit of claim 1, wherein the central magnetic part comprises a central magnetic steel and a central magnetic conducting plate, the central magnetic steel having two opposite sides respectively connected to the central magnetic conducting plate and the magnetic conducting yoke; wherein the edge magnetic part comprises an edge magnetic steel and an edge magnetic conducting plate, and the edge magnetic steel having two opposite sides respectively connected to the edge magnetic conducting plate and the magnetic conducting yoke; and wherein the central magnetic conducting plate and/or the edge magnetic conducting plate are composed of a cobalt alloy material.

4. The sound producing unit of claim 3, wherein
the cobalt alloy material of the central magnetic conducting plate comprises a material grade of Co₅₀ or Co₂₇; and/or
the cobalt alloy material of the edge magnetic conducting plate comprises a material grade of Co₅₀ or Co₂₇; and/or
the cobalt alloy material in any one of the housing, the central magnetic conducting plate, and the edge magnetic conducting plate has a magnetic conductivity of no less than 5200 Gs/Oe; and/or,
the cobalt alloy material in any one of the housing, the central magnetic conducting plate, and the edge magnetic conducting plate has a saturation magnetic induction intensity B of no less than 2.25 T.

5. The sound producing unit of claim 3, wherein
the edge magnetic conducting plate has a thickness of no greater than 0.23 mm; and/or,
the central magnetic conducting plate has a thickness of no greater than 0.23 mm; and/or,
the magnetic conduction yoke has a thickness of no greater than 0.23 mm.

6. The sound producing unit of claim 3, wherein
the sound producing unit further comprises a vibration system which comprises a diaphragm, the diaphragm comprising: a corrugated rim, an inner fixing part provided on an inner side of the corrugated rim, and an outer fixing part provided on an outer side of the corrugated rim, the outer fixing part being connected to the housing, the corrugated rim being configured to be recessed towards the edge magnetic conducting plate, the edge magnetic conducting plate being provided with a first avoidance slot which is opposite to the corrugated rim and configured to extends away from the diaphragm, the first avoidance slot having a depth of no greater than 0.1 mm.

7. The sound producing unit of claim 1, wherein the magnetic conducting yoke is composed of a cobalt alloy material comprising a material grade of Co₅₀ or Co₂₇.

8. The sound producing unit of claim 7, wherein
a cobalt alloy material of the magnetic conducting yoke has a magnetic conductivity of no less than 5200 Gs/Oe; and/or
a cobalt alloy material of the magnetic conducting yoke has a saturation magnetic induction intensity B of no less than 2.25 T.

9. The sound producing unit of claim 7, wherein
the edge magnetic part and the central magnetic part are spaced apart to form a magnetic gap; the sound producing unit further comprises a vibration system which comprises a diaphragm assembly, a voice coil, and a damper assembly, an outer circumference of the diaphragm assembly being fixed to the housing, a first end of the voice coil being connected to the diaphragm assembly, a second end of the voice coil being inserted into the magnetic gap, two ends of the damper assembly being respectively connected to the second end of the voice coil and to the housing, the magnetic conducting yoke being provided with a second avoidance slot opposite to the damper assembly to extend away from the damper assembly, and the depth of the second avoidance slot being between 0.05 mm and 0.15 mm.

10. The sound producing unit of claim 9, wherein the diaphragm assembly comprises a diaphragm and a vibrating plate, an outer circumference of the diaphragm being connected to the housing, the vibrating plate being connected to the diaphragm and to the first end of the voice coil, and the vibrating plate comprises a main body part and a beading part provided on an outer circumference of the main body part, the beading part being bent towards the magnetic system relative to the main body part, the diaphragm being provided at an inner side of an inner fixing part connected to the beading part, a top surface of the inner fixing part and a top surface of the main body part being located in the same plane.

11. The sound producing unit of claim 9, wherein the housing comprises a first edge part and a second edge part in a head-to-tail connection to each other, the first edge part being formed as a cobalt alloy material piece, the second edge part being formed as a plastic material piece, the second edge part being provided with a sound hole in communication with an acoustic cavity inside the housing; the housing further comprising a mesh assembly covering the sound hole, the mesh assembly being adhesively connected to the second edge part or integrally molded with the second edge part.

12. The sound producing unit of claim 11, wherein the edge magnetic part comprises an edge magnetic steel and an edge magnetic conducting plate, and the edge magnetic steel having two opposite sides respectively connected to the edge magnetic conducting plate and the magnetic conducting yoke; the edge magnetic conducting plate comprising a first edge magnetic conducting plate located on the first edge part and a second edge magnetic conducting plate located on the second edge part, the first edge magnetic conducting plate and the first edge part being formed as an integral molding piece.

13. The sound producing unit of claim 1, wherein the housing comprises a first edge part, a second edge part, and a connecting part, the first edge part and the second edge part intersecting at a position forming a corner, the connecting part being located at the corner and connected respectively to the first edge part and the second edge part, the connecting part being formed as a plastic material piece, and the first edge part and the second edge part being formed as cobalt alloy material pieces.

14. The sound producing unit of claim 13, wherein the edge magnetic part comprises an edge magnetic steel and an edge magnetic conducting plate, the edge magnetic steel having two opposite sides respectively connected to the edge magnetic conducting plate and the magnetic conducting yoke; the edge magnetic conducting plate comprising a first edge magnetic conducting plate located on the first edge part and a second edge magnetic conducting plate located on the second edge part, the first edge magnetic conducting plate and the first edge part being formed as an integral molding piece, and the second edge magnetic conducting plate and the second edge part being formed as an integral molding piece.

15. The sound producing unit of claim 1, wherein the sound producing unit is of a height no greater than 1.8 mm.

16. An electronic device, comprising a sound producing unit of claim 1.
